(19) United States
(12) Patent Application Publication
(10) Pub. No.: US 2013/0119804 A1
(43) Pub. Date: May 16, 2013

(54) MAGNETIC COUPLER

(71) Applicant: Andrew Boyd French, Karuah (AU)

(72) Inventor: Andrew Boyd FRENCH, Karuah (AU)

(73) Assignee: Andrew Boyd FRENCH, Karuah (AU)

(21) Appl. No.: 13/735,498

(22) Filed: Jan. 7, 2013

Related U.S. Application Data
(63) Continuation of application No. 13/508,938, now abandoned.

(30) Foreign Application Priority Data
Nov. 9, 2009 (AU) 2009905479

(51) Int. Cl. H02K 49/10

(52) U.S. Cl. CPC H02K 49/106
USPC 310/103

(57) ABSTRACT

A magnetic coupling comprising: an outer support having an interior cavity defined by an cavity periphery and being rotatable around an axis of rotation, the outer support having a plurality of outer magnets arranged at or adjacent the cavity periphery; an inner support at least a portion of which is located within the cavity, the inner support being rotatable about an axis and having a plurality of inner magnets arranged around and at or adjacent to a periphery wherein the inner magnets and the outer magnets are arranged such that at a given time, at least a portion of at least some of the inner magnets are located between at least a portion of at least some of the outer magnets.

### TECHNICAL FIELD

The present invention relates generally to a magnetic coupling and more particularly though not exclusively, to drives and bearings employing magnetic couplings.

### BACKGROUND

Known methods of transferring drive from engines and motors to rotary parts such as gearboxes, pumps, alternators, generators and compressors is accomplished by various forms of physical couplings, including pulley belts, chains, gears, discs, cogs and other couplings. There are many problems associated with mechanical couplings such as the requirement for periodic lubrication of gears, close alignment requirements of the various components, and issue of wear and tear. Energy losses in the form of friction and heat loss can be considerable in such apparatus.

### SUMMARY OF THE INVENTION

In a first aspect the present invention provides a magnetic coupling comprising: an outer support having an interior cavity defined by an cavity periphery and being rotatable around an axis of rotation, the outer support having a plurality of outer magnets arranged at or adjacent the cavity periphery; an inner support at least a portion of which is located within the cavity, the inner support being rotatable about an axis and having a plurality of inner magnets arranged around and at or adjacent to a periphery wherein the inner magnets and the outer magnets are arranged such that at a given time, at least a portion of at least some of the inner magnets are located between at least a portion of at least some of the outer magnets.

In one form, the outer magnets and the inner magnets can be each oriented so that the poles of said at least some outer magnets provide a repulsive magnetic force to said at least some inner magnets.

In one form, the inner support is a disc that is mounted to rotate about an inner axis located at or near its centre and the outer support is an annular ring mounted to rotate about the same axis.

In one form the inner support is mounted on and adapted to rotate with a shaft.

In one form the inner magnets and the outer magnets are ovaloid, obround or rhomboid.

In one form the inner magnets are shaped such that they extend outwardly from the inner support to an inner magnet point.

In one form the inner magnets extend from an engagement portion located within the inner support to an inner magnet point extending outwardly from the inner support. In one form the engagement portion has a jagged edge.

In one form the outer magnets are shaped such that they extend inwardly from the outer support to an outer magnet point.

In one form the outer magnets are substantially extend from an engagement portion located within the outer support to an outer magnet point extending inwardly from the outer support. In one form the engagement portion has a jagged edge.

In one form the inner and outer magnets are arranged such that at least some of the inner magnet points are located between at least some of the outer magnet points.

In one form one of the inner or outer supports acts as a drive wheel while the other of the inner or outer supports acts as a driven wheel.

In one form, the magnets on at least one support can be energised by at least one electromagnet to induce rotation between the inner support and the outer support.

In one form each of the inner magnets has an elongate axis that extends outwardly from the axis of rotation of the inner support.

In one form each of the outer magnets has an elongate axis that extends inwardly from the outer support toward the axis of rotation of the outer support.

In some embodiments, the magnets in each support can be mounted to project beyond the outer periphery thereof, or are mounted to recess into the outer periphery.

### BRIEF DESCRIPTION OF THE DRAWINGS

It is convenient to herein describe an embodiment of the present invention with reference to the accompanying drawings. The particularity of the drawings and the related description is to be understood as not superseding the generality of the preceding broad description of the invention.

In the drawings:

FIG. 1 shows a side view of one embodiment of inner and outer supports which comprise part of the magnetic coupling in accordance with the invention;

FIG. 2 shows an isometric view of the embodiment shown in FIG. 1;

FIG. 3 shows a side view of a further embodiment of inner and outer supports which comprise part of the magnetic coupling in accordance with the invention;

### DETAILED DESCRIPTION OF EMBODIMENTS OF THE INVENTION

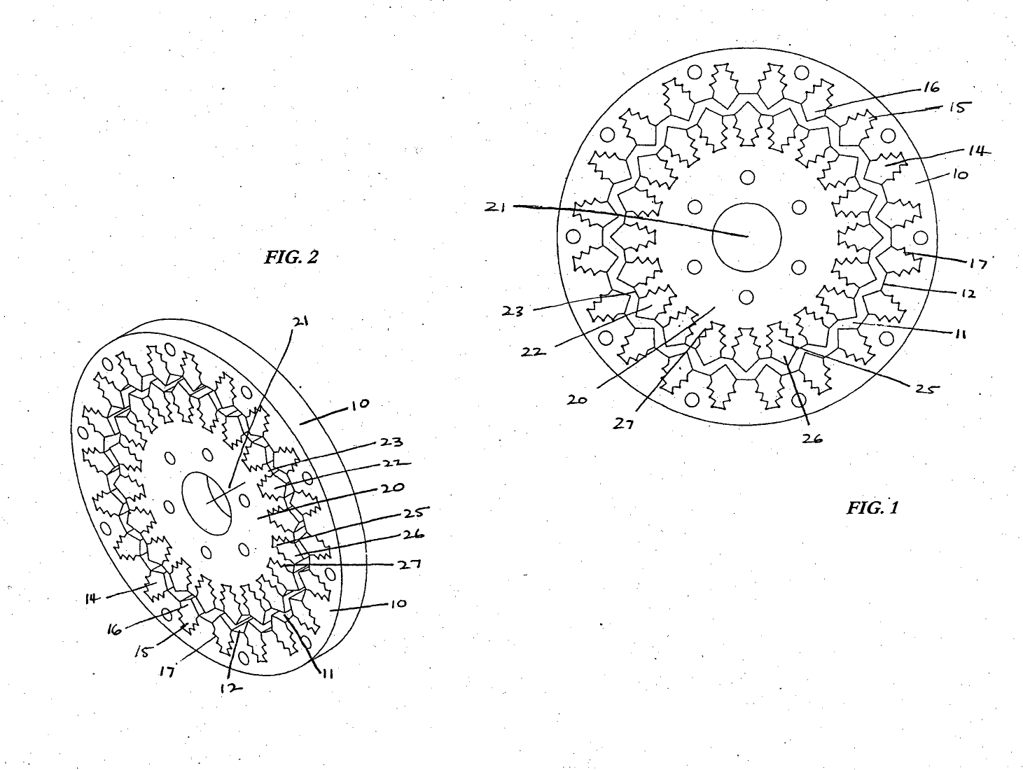

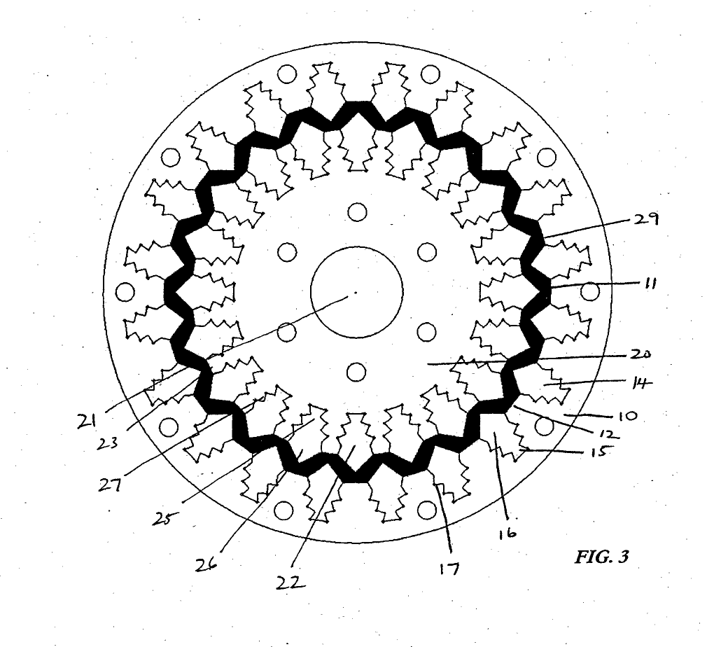

Referring to the drawings an embodiment of part of a magnetic coupling is shown in FIGS. 1 and 2. The magnetic coupling 1 comprises an outer support 10 that is annular in shape. The outer support 10 has an interior cavity 11 surrounded by an inner periphery 12 of the outer support 10. Outer magnets 14 are located in the outer support 10.

The magnetic coupling further includes an inner support 20. The inner support 20 is disc shaped and is adapted to rotate about an axis 21 substantially at its centre. The inner support includes inner magnets 22 which are positioned on the periphery 23 of inner support 20.

The inner support engages a shaft (not illustrated) or series of shafts in order to transfer drive.

In the embodiment shown, the inner support 20 and outer support 10 are located in the same vertical plane such that the inner support 20 is located within the interior cavity 11 of the outer support 10.

Outer magnets 14 and inner magnets 22 are in the form of permanent magnets of the same polarity. As shown in the drawings, the outer magnets 14 are located at or adjacent to the inner periphery 12 of the outer support 10. The outer magnets 14 are shaped generally as rhomboid figures extending from an engagement end 15 to an outer magnet point 16. The engagement end 15 has jagged edges 17 to allow the outer magnets 14 to be firmly embedded in the outer support 10. Similarly the inner magnets 22 are shaped generally as rhomboid figures extending from an engagement end 25 to an outer magnet point 26. The engagement end 25 has jagged edges 27 to allow the inner magnets 22 to be firmly embedded in the inner support 20. The inner magnets 22 extend outwardly from the inner support 20.

The inner support 20 is positioned within the interior cavity 11 such that each inner magnet point 26 is positioned between two outer magnet points 16. In the embodiment shown, the inner magnets 22 that are embedded in the inner disc 20 are each oriented such that the polarity of the outer face 28, 29 of each inner magnet matches the polarity of the nearest outer face of an outer magnet 18,19 positioned adjacent and extending into the cavity 11. In the embodiment shown each of the inner magnets 22 has a North pole which is aligned with a North pole of an outer magnet 14 embedded in the outer support 10. Similarly each of the South pole of the inner magnets 22 embedded in the inner support 20 has a South pole which is aligned with a South pole of an outer magnet 14 embedded in the outer support 10.

The inner support 20 and the outer support 10 are oriented such that when one or other of the inner and outer supports are rotated, the other of the inner or outer supports is caused to rotate due to repulsive forces. That is if the inner support 20 is rotated the outer support 10 is caused to rotate and if the outer support 10 is rotated, the inner support 20 is caused to rotate in response. Either of the inner support 20 and outer support 10 can be independently connected to and rotated by any rotational energy source. In some embodiments, the offset between the first and second shaft may be adjusted to control the extent of magnetic interaction, so long as that, at a given time, at least some portion of the magnets 22 on the primary disc 10 are located between at least some of the magnets 28, 30 on the secondary disc(s) 14, 16.

The rhomboid-shaped inner magnets 22 are located in the inner support such that an elongate axis extending through the inner magnet 22 extends outwardly from the axis of rotation of the inner support. The outer magnets 14 are located in the outer support such that an elongate axis extending from the engagement end 15 through the outer magnet point 16 extends inwardly from the outer support toward the axis of rotation of the outer support. The axis of rotation of the outer support and inner support in the embodiment shown are in the same position.

The inner support 20 and outer support 10 can each be used as a drive member or a driven member. Rotation of each causes the other to rotate without contact between the inner magnets 22 and outer magnets 14 or the inner support 20 and outer support 10. This means that vibration is minimally transmitted between the drive member and the driven member and no lubricant is required between the two members. This adds to a high efficiency coupling.

In the embodiment shown in FIG. 3, in all other respects the apparatus shown is similar to that described in FIGS. 1 and 2. However a material 29 such as an elastomer, a synthetic polymer or similar material with hardness in the range of shore 40 to shore 80 is located in the interior cavity 11 between the inner support 20 and the outer support 10.

In further embodiments, the orientation of the shape of the embedded magnets on the primary disc need not be aligned with the orientation of the embedded magnets.

Whilst the invention has been described with reference to a specific embodiment, it should be appreciated that the invention can be embodied in many other forms.

It is to be understood that, if any prior art information is referred to herein, such reference does not constitute an admission that the information forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

1. A magnetic coupling, comprising:
an outer support rotatable about an axis of rotation and having an interior cavity defined by a cavity periphery, a plurality of outer magnets being arranged at or adjacent the cavity periphery; and
an inner support at least a portion of which is located within the interior cavity, the inner support being rotatable about an axis and having a plurality of inner magnets arranged at or adjacent to its periphery;
wherein the inner magnets and the outer magnets are arranged such that at a given time, at least a portion of at least some of the inner magnets are located between at least a portion of at least some of the outer magnets.

2. The magnetic coupling according to claim 1, wherein the outer magnets and the inner magnets are oriented such that the poles of said at least some outer magnets provide a repulsive magnetic force to said at least some inner magnets.

3. The magnetic coupling according to claim 1, wherein the inner support is a disc that is mounted to rotate about an inner axis located at or near its centre.

4. The magnetic coupling according to claim 1 wherein the outer support is an annular ring mounted to rotate about an axis in the same position as the inner axis.

5. The magnetic coupling according to claim 1, wherein inner support is mounted on and adapted to rotate with a shaft.

6. The magnetic coupling according to claim 1, wherein the inner magnets are at least one of ovaloid, obround and rhomboid.

7. The magnetic coupling according to claim 1, wherein the outer magnets are at least one of ovaloid, obround and rhomboid.

8. The magnetic coupling according to claim 1, wherein the inner magnets are located and shaped such that they extend outwardly from the inner support to an inner magnet point.

9. The magnetic coupling according to claim 8, wherein the inner magnets extend from an engagement portion located within the inner support to an inner magnet point extending outwardly from the inner support.

10. The magnetic coupling according to claim 9, wherein the engagement portion has a jagged edge.

11. The magnetic coupling according to claim 8 wherein the outer magnets extend from an engagement portion located within the outer support to an outer magnet point extending inwardly from the outer support.

12. The magnetic coupling according to claim 11, wherein the inner and outer magnets are arranged such that at least some of the inner magnet points are located between at least some of the outer magnet points.

13. The magnetic coupling according to claim 1, wherein one of the inner or outer supports acts as a drive member while the other of the inner or outer supports acts as a driven member.

14. The magnetic coupling according to claim 1, wherein the magnets on at least one support can be energised by at least one electromagnet to induce rotation between the inner support and the outer support,

15. The magnetic coupling according to claim 1, wherein each of the inner magnets has an elongate axis that extends outwardly from the axis of rotation of the inner support.

16. The magnetic coupling according to claim 1, wherein each of the outer magnets has an elongate axis that extends inwardly from the outer support toward the axis of rotation of the outer support.

17. The magnetic coupling according to claim 1, wherein at least one of the inner and outer magnets projects beyond an outer periphery of the inner and outer supports, respectively.

18. The magnetic coupling according to 1, wherein at least one of the inner and outer magnets are mounted to recess into an outer periphery of at least one of the inner and outer supports, respectively.

19. The magnetic coupling according to claim 1 wherein an elastomer is located between the outer support and the inner support.
